(19) United States
(12) Patent Application Publication
(10) Pub. No.: US 2015/0092964 A1
(43) Pub. Date: Apr. 2, 2015

(54) MICROPHONE

(71) Applicant: SAMSUNG ELECTRO-MECHANICS CO., LTD., Suwon-Si (KR)

(72) Inventors: Byung Hun Kim, Suwon-Si (KR); Hwa Sun Lee, Suwon-Si (KR)

(73) Assignee: SAMSUNG ELECTRO-MECHANICS CO., LTD., Suwon-Si (KR)

(21) Appl. No.: 14/457,093

(22) Filed: Aug. 11, 2014

(30) Foreign Application Priority Data
Sep. 30, 2013 (KR) 10-2013-0116383
Oct. 22, 2013 (KR) 10-2013-0126091

(51) Int. Cl. H04R 1/08

(52) U.S. Cl. CPC H04R 1/08
USPC 381/176

(57) ABSTRACT

Disclosed herein is a microphone including: a membrane; a fixed electrode part positioned at the outside of the membrane; and an elastic support part connecting the membrane and the fixed electrode part to each other so as to enable displacement of the membrane, wherein one surface of the membrane and one surface of the fixed electrode part facing each other are formed with conductive parts, respectively.

### CROSS REFERENCE TO RELATED APPLICATION

This application claims the benefit of Korean Patent Application No. 10-2013-0116383, filed on Sep. 30, 2013, entitled “Microphone”, and of Korean Patent Application No. 10-2013-0126091, filed on Oct. 22, 2013, entitled “Microphone” which are hereby incorporated by reference in its entirety into this application.

### BACKGROUND OF THE INVENTION

1. Technical Field

The present invention relates to a microphone.

2. Description of the Related Art

As portable electronic products are increased, an electrostatic microphone manufactured by a micro electro mechanical systems (MEMS) process has been widely used.

More specifically, a microphone according to the prior art including the Prior Art Document is configured of a membrane, a back plate, a packaging structure, an application specific integrated circuit (ASIC), and other portions supporting the structure.

In addition, the back plate and the membrane are installed so as to have a predetermined distance therebetween, and when a voltage potential is applied to the microphone, the microphone is charged with electric charges, thereby having capacitance.

In addition, when a sound wave is transferred to the membrane, the membrane is deformed by pressure of the sound wave, which changes the distance between the membrane and the back plate and causes a change ΔC in a capacitance value. ΔC is electrically measured, such that the sound wave is converted into an electric signal.

As described above, as the microphone according to the prior art is implemented in a manner in which the sound wave is converted into the electric signal by ΔC generated by a change in the distance between the membrane and the back plate, the microphone is structurally complicated, and ΔC is not linearly changed, such that reliability may be deteriorated.

In addition, as the microphone according to the prior art is implemented in a manner in which the sound wave is converted into the electric signal due to ΔC generated by a change in the distance between the membrane and the back plate, the microphone is structurally complicated, and ΔC is not linearly changed, such that there are problems in that reliability may be deteriorated and it is impossible to implement an accurate microphone.

### PRIOR ART DOCUMENT

### Patent Document

(Patent Document 1) U.S. Pat. No. 6,535,460

### SUMMARY OF THE INVENTION

The present invention has been made in an effort to provide a microphone capable of more accurately converting a sound wave into an electric signal by detecting a change value of capacitance due to a change in an area of an overlapped portion between a fixed electrode part positioned in a direction perpendicular to a displacement direction of a membrane and the membrane.

In addition, the present invention has been made in an effort to provide a microphone capable of being implemented without a back plate to thereby decrease a production cost, not having air-resistance or air damping by the back plate to thereby obtain high sensitivity, and linearly reacting to a sound pressure and having a simple structure to thereby have improved productivity and product reliability.

Further, the present invention has been made in an effort to provide a microphone capable of more accurately converting a sound wave into an electric signal by detecting a change value of capacitance due to a change in an area of an overlapped portion between a fixed electrode part positioned in a direction perpendicular to a displacement direction of a membrane and the membrane.

Furthermore, the present invention has been made in an effort to provide a microphone capable of being more accurately implemented by simultaneously detecting a change value of an area of an overlapped portion between a membrane and a fixed electrode part and a distance displacement between the membrane and a black plate, calculating a change value of the capacitance using the detected value, and converting a sound wave into an electric signal through the change value of the capacitance.

According to a preferred embodiment of the present invention, there is provided a microphone including: a membrane; a fixed electrode part positioned at the outside of the membrane; and an elastic support part connecting the membrane and the fixed electrode part to each other so as to enable displacement of the membrane, wherein one surface of the membrane and one surface of the fixed electrode part facing each other are formed with conductive parts, respectively.

The fixed electrode part may be positioned so as to be spaced apart from the membrane in a direction orthogonal to a displacement direction of the membrane.

A side wall part may be formed at an end portion of the membrane in a direction orthogonal to a displacement direction of the membrane and a conductive part may be formed on the side wall part so as to face the fixed electrode part.

The membrane may be formed of a thin film, and the side wall part is formed so as to protrude in the displacement direction of the membrane.

A conductive part may be formed on the fixed electrode part so as to face the conductive part formed on the side wall part of the membrane.

An end portion of the conductive part formed on the side wall part of the membrane may be positioned at the center of the conductive part of the fixed electrode part in the displacement direction of the membrane.

The elastic support part may connect the membrane and the fixed electrode part to each other in a direction orthogonal to a displacement direction of the membrane.

A plurality of elastic support parts may connect the membrane and the fixed electrode part to each other at equidistance.

The microphone may further include a support part coupled to the fixed electrode part so as to support the fixed electrode part in the displacement direction of the membrane.

According to another preferred embodiment of the present invention, there is provided a microphone including: a membrane; a fixed electrode part spaced apart from the membrane in a direction orthogonal to a displacement direction of the membrane; and an elastic support part connecting the membrane and the fixed electrode part so as to enable displacement of the membrane, wherein one surface of the membrane and one surface of the fixed electrode part facing each other are formed with conductive parts, respectively, a side wall part is formed at an end portion of the membrane in the direction orthogonal to the displacement direction of the membrane, a conductive part is formed on the side wall part so as to face the fixed electrode part, a plurality of protrusion parts protruding toward the fixed electrode part are formed at the side wall part of the membrane, and a groove part corresponding to the protrusion part is formed at the fixed electrode part.

Conductive parts facing each other may be formed at the protrusion part of the side wall part and the groove part of the fixed electrode part.

According to another preferred embodiment of the present invention, there is provided a microphone including: a membrane; a fixed electrode part positioned at the outside of the membrane; and a support member coupled to a central portion of the membrane so as to enable displacement of the membrane at both sides thereof, wherein one surface of the membrane and one surface of the fixed electrode part facing each other are formed with conductive parts, respectively.

The fixed electrode part may be positioned so as to be spaced apart from the membrane in a direction orthogonal to a displacement direction of the membrane.

The membrane may include a center part to which the support member is coupled, and one side part and the other side part formed so as to be symmetrical to each other at both sides of the center part.

Shapes of one side part and the other side part may be symmetrical to each other.

A side wall part may be formed at an end portion of the membrane in a direction orthogonal to a displacement direction of the membrane, and a conductive part may be formed on the side wall part so as to face the fixed electrode part.

The membrane may be formed of a thin film, and the side wall part may be formed so as to protrude in the displacement direction of the membrane.

A conductive part may be formed on the fixed electrode part so as to face the conductive part formed on the side wall part of the membrane.

An end portion of the side wall part of the membrane on which the conductive part is formed may be positioned at the center of the conductive part of the fixed electrode part in the displacement direction of the membrane.

The support member may include: a center fixing part formed so as to correspond to the center part of the membrane; and a frame part fixedly coupled to the fixed electrode part.

The microphone may further include a support part coupled to the fixed electrode part so as to support the fixed electrode part in a displacement direction of the membrane.

According to another preferred embodiment of the present invention, there is provided a microphone including: a membrane; a fixed electrode part spaced apart from the membrane in a direction orthogonal to a displacement direction of the membrane; and a support member coupled to a central portion of the membrane so as to enable displacement of the membrane at both sides thereof, wherein one surface of the membrane and one surface of the fixed electrode part facing each other are formed with conductive parts, respectively, a side wall part is formed at an end portion of the membrane in the direction orthogonal to the displacement direction, a conductive part is formed on the side wall part, a plurality of protrusion parts protruding toward the fixed electrode part are formed at the side wall part of the membrane, and a groove part corresponding to the protrusion part is formed at the fixed electrode part.

Conductive parts may be formed on the protrusion part of the side wall part and the groove part of the fixed electrode part so as to face each other.

According to another preferred embodiment of the present invention, there is provided a microphone including: a membrane; a fixed electrode part positioned at the outside of the membrane; a back plate positioned at the outside of the membrane; and a support member coupled to a central portion of the membrane so as to enable displacement at both sides of the membrane, wherein one surface of the membrane and one surface of the fixed electrode part facing each other are formed with conductive parts, respectively, and one surface of the membrane and one surface of the back plate facing each other are formed with conductive parts, respectively.

The fixed electrode part may be positioned so as to be spaced apart from the membrane in a direction orthogonal to a displacement direction of the membrane.

The back plate may be positioned so as to be spaced apart from the membrane in a displacement direction of the membrane.

The membrane may include a center part to which the support member is coupled, and one side part and the other side part formed so as to be symmetrical to each other at both sides of the center part.

A side wall part may be formed at an end portion of the membrane in a direction orthogonal to a displacement direction of the membrane, and a first conductive part may be formed on the side wall part so as to face the fixed electrode part.

The membrane may be formed of a thin film, and the side wall part may be formed so as to protrude in the displacement direction of the membrane.

A conductive part may be formed on the fixed electrode part so as to face the first conductive part formed on the side wall part of the membrane.

An end portion of the side wall part of the membrane on which the conductive part is formed may be positioned at the center of the conductive part of the fixed electrode part in the displacement direction of the membrane.

The membrane may include a second conductive part formed so as to face the back plate in a displacement direction, and the back plate is positioned below the membrane and includes a conductive part formed so as to face the second conductive part.

The back plate may include a hole formed for a flow of a sound wave and a stopper formed at one surface thereof facing the membrane.

The support member may include: a center fixing part formed so as to correspond to a center part of the membrane; and a frame part fixedly coupled to the fixed electrode part.

The microphone may include a support part coupled to the fixed electrode part so as to support the fixed electrode part in a displacement direction of the membrane.

According to another preferred embodiment of the present invention, there is provided a microphone include: a membrane; a fixed electrode part positioned at the outside of the membrane; a back plate positioned at the outside of the membrane; and a support member coupled to a central portion of the membrane so as to enable displacement at both sides of the membrane, wherein one surface of the membrane and one surface of the fixed electrode part facing each other are formed with conductive parts, respectively, one surface of the membrane and one surface of the back plate facing each other are formed with conductive parts, respectively, the membrane includes a plurality of protrusion parts protruding toward the fixed electrode part, and the fixed electrode part includes a groove part formed therein so as to correspond to the protrusion part.

The protrusion part of the membrane and the groove parts of the fixed electrode parts may be formed with conductive parts facing each other.

The fixed electrode part may be positioned so as to be spaced apart from the membrane in a direction orthogonal to a displacement direction of the membrane, and the back plate may be positioned so as to be spaced apart from the membrane in the displacement direction of the membrane.

The membrane may include a center part to which the support member is coupled, and one side part and the other side part formed so as to be symmetrical to each other at both sides of the center part.

A side wall part protruding in a displacement direction of the membrane may be formed at an end portion of the membrane in a direction orthogonal to the displacement direction of the membrane, and a first conductive part may be formed on the side wall part so as to face the fixed electrode part.

The membrane may include a second conductive part formed so as to face the back plate in a displacement direction, and the back plate may be positioned below the membrane and includes a conductive part formed so as to face the second conductive part.

The support member may include: a center fixing part formed so as to correspond to a center part of the membrane; and a frame part fixedly coupled to the fixed electrode part.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view schematically showing a microphone according to a first preferred embodiment of the present invention;

FIG. 2 is a schematic plan view of the microphone shown in FIG. 1;

FIG. 3 is a cross-sectional view showing the microphone taken along line A-A of FIG. 1;

FIG. 4 is a schematic cross-sectional view showing the microphone taken along line B-B of FIG. 1;

FIG. 5 is a view of a usage state of the microphone shown in FIG. 1;

FIG. 6 is a plan view schematically showing a microphone according to a second preferred embodiment of the present invention;

FIG. 7 is a perspective view schematically showing a microphone according to a third preferred embodiment of the present invention;

FIG. 8 is a schematic plan view of the microphone shown in FIG. 7;

FIG. 9 is a cross-sectional view showing the microphone taken along line A-A of FIG. 7;

FIG. 10 is a view of schematically showing a use state of the microphone shown in FIG. 7;

FIG. 11 is a plan view schematically showing a microphone according to a fourth preferred embodiment of the present invention;

FIG. 12 is a perspective view schematically showing a microphone according to a fifth preferred embodiment of the present invention;

FIG. 13 is a schematic plan view of the microphone shown in FIG. 12;

FIG. 14 is a cross-sectional view showing the microphone taken along line A-A of FIG. 12;

FIG. 15 is a view of a usage state of the microphone shown in FIG. 12;

FIG. 16 is a plan view schematically showing a microphone according to a sixth preferred embodiment of the present invention; and

FIG. 17 is a cross-sectional view showing the microphone taken along line A-A of FIG. 16.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

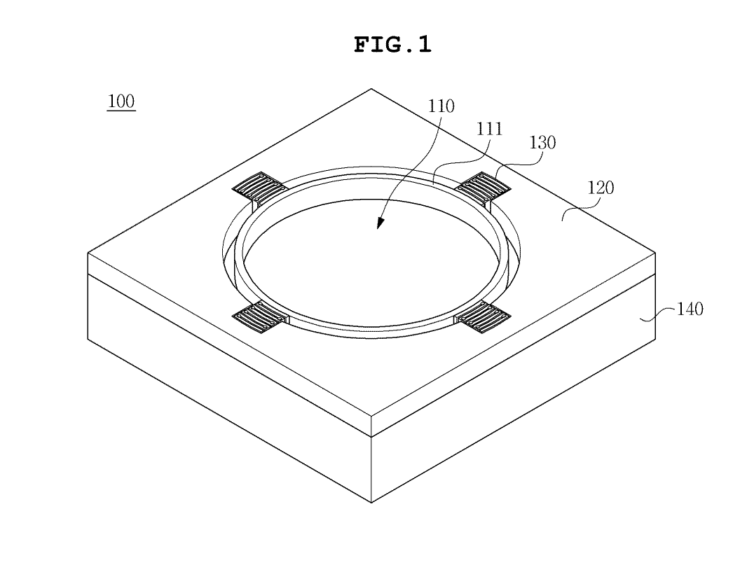

FIG. 1 is a perspective view schematically showing a microphone according to a first preferred embodiment of the present invention. As shown in FIG. 1, the microphone 100 includes a membrane 110, a fixed electrode part 120, an elastic support part 130, and a support part 140.

In addition, when a sound wave is applied to the microphone 100 from the outside, displacement is generated in a state in which the membrane 110 is elastically supported by the elastic support part 130, and a change in capacitance with respect to an overlapped surface of the fixed electrode part 120 and the membrane 110 by the displacement is detected, such that the sound wave is converted into an electric signal.

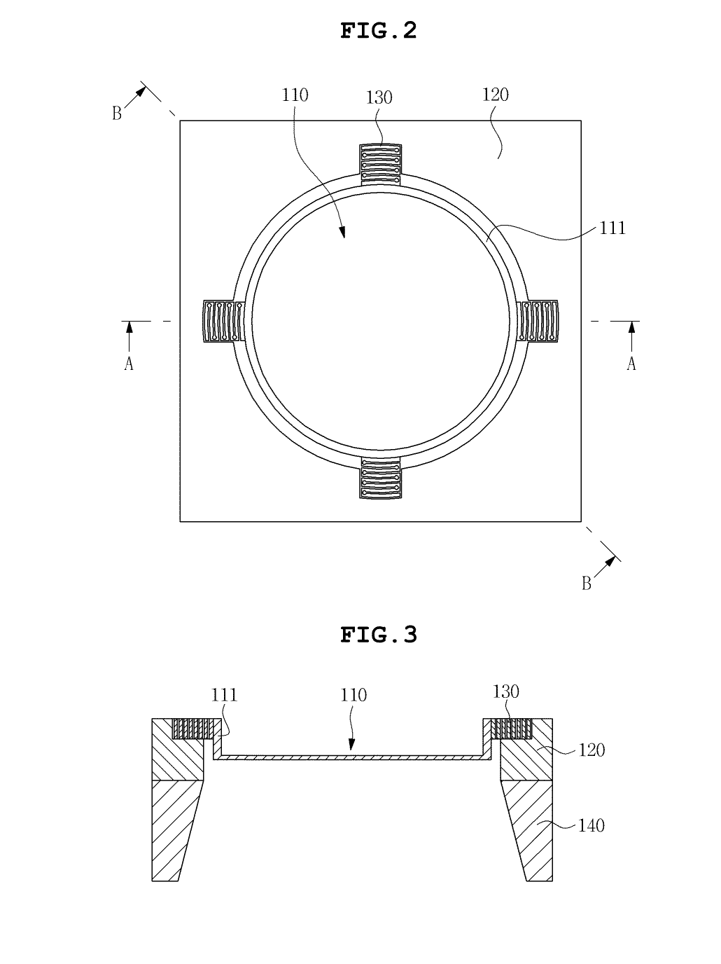

Detailed technical configurations of the microphone according to the preferred embodiment of the present invention and systematic coupling between constituent components will be described in detail with reference to FIGS. 2 to 4.

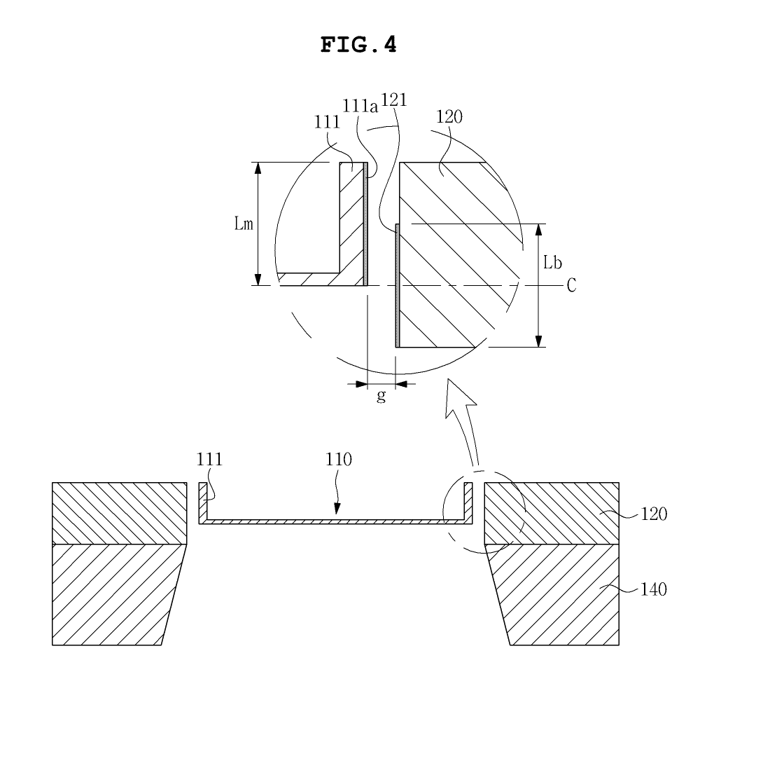

FIG. 2 is a schematic plan view of the microphone shown in FIG. 1, FIG. 3 is a schematic cross-sectional view showing the microphone taken along line A-A of FIG. 1, and FIG. 4 is a schematic cross-sectional view showing the microphone taken along line B-B of FIG. 1.

More specifically, the membrane 110, which is to be displaced by the sound wave, may be formed of a thin film in a disk shape.

In addition, the membrane 110 may have conductivity and be formed so that a conductive part is formed on at least some thereof. That is, the conductive part may be formed on one surface of the membrane 110 facing the fixed electrode part 120 in order to detect the change in capacitance generated at the surface facing the fixed electrode part 120.

To this end, an end portion of the membrane 110 in a direction perpendicular to a displacement direction is formed with a side wall part 111 facing the fixed electrode part.

In addition, as the membrane is formed in the disk shape, the side wall part 111 may be formed in a circumferential direction at an end portion in a radical direction, and a conductive part 111a may be formed on the side wall part 111. As a result, the side wall part 111 is to secure a forming region of the conductive part 111a for detecting the displacement of the membrane.

In addition, as the membrane 110 is formed of the thin film, the side wall part 111 may be formed at the end portion of the membrane 110 so as to erect, that is, protrude in the displacement direction of the membrane 110.

Further, the conductive part 111a is formed on the side wall part 111 so as to face the fixed electrode part 120.

Next, the fixed electrode part 120, which is to form ΔC with a change in an area of an overlapped portion between the fixed electrode part 120 and the membrane 110, is positioned at an outer peripheral portion of the membrane 110. In addition, the fixed electrode part 120 may be positioned so as to be spaced apart from the membrane in the direction orthogonal to the displacement direction of the membrane 110.

Further, the fixed electrode part 120 may be disposed to be spaced apart from the membrane 110 so as to have a predetermined gap g therebetween. The reason is to allow strong wind or low frequency flow to be discharged through the gap between the membrane 110 and the fixed electrode part 120 to thereby prevent the deformation of the membrane and allow the membrane 110 to be freely displaced by the sound wave in a vertical direction.

In addition, a conductive part 121 is formed on the fixed electrode part 120 so as to face the conductive part 111a of the membrane.

Further, as shown in an enlarged view of FIG. 4, an end portion of the conductive part 111a of the membrane 110 may be formed so as to be positioned at the center of the conductive part 121 of the fixed electrode part 120 in a vibration direction of the membrane 110.

That is, in the displacement direction of the membrane 110, when a length of the conductive part 111a of the membrane 110 is defined as Lm and a length of the conductive part 121 of the fixed electrode part 120 is defined as Lb, the end portion of the conductive part 111a is positioned at a portion corresponding to Lb×½, which is the center of the conductive part 121, and a distance at which the membrane 110 may be maximally moved by the sound pressure becomes Lb×½.

Next, the elastic support part 130 connects the membrane 110 and the fixed electrode part 120 to each other and allows the membrane 110 to be elastically supported by the fixed electrode part 120. In addition, the elastic support part 130 may have a structure in which a groove is formed in a diaphragm plate.

Further, the elastic support part 130 connects the membrane 110 and the fixed electrode part 120 to each other in the direction orthogonal to the displacement direction of the membrane 110.

To this end, one end of the elastic support part 130 is coupled to the side wall part 111 of the membrane 110, and the other end of the elastic support part 130 is coupled to one surface of the fixed electrode part facing the side wall part 111.

In addition, as an example, the case in which four elastic support parts 130 are provided is shown in FIG. 2, and a plurality of elastic support parts may be variously formed at equidistance.

Next, the support part 140 supports the fixed electrode part 120. In addition, the support part 140 may be coupled to a lower portion of the fixed electrode part 120 in the displacement direction of the membrane. Further, the support part 140 may be formed of a silicon substrate.

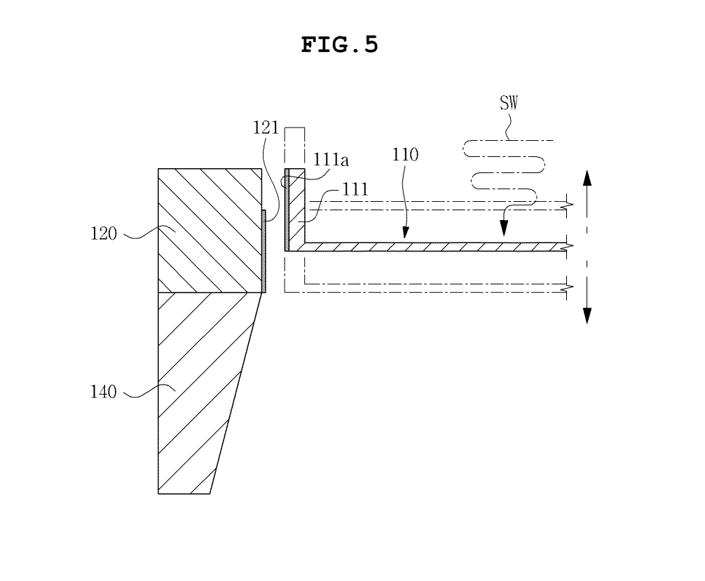

FIG. 5 is a view of a usage state of the microphone shown in FIG. 1. As shown in FIG. 5, in the case in which a sound wave (SW) is applied to the membrane 110 from the outside, displacement is generated therein.

That is, the membrane 110 is displaced by the SW and elastically supported by the elastic support part 130, such that a vibration property may be improved, and recovering force may be provided.

In addition, in the case in which displacement of the membrane 110 is generated, the area of the overlapped portion between the conductive part 111a of the membrane 110 and the conductive part 121 of the fixed electrode part 120 is changed, such that capacitance is changed, thereby generating ΔC.

That is, capacitance C is defined as follows.

C=εr·εA/g

(Where, εr=permittivity, ε=electric constant, A=area of overlapped portion, and g=distance between the membrane and the fixed electrode part.)

In addition, as described above, as the capacitance C is changed according to the change in the area A of the overlapped portion between the conductive part 111a of the membrane 110 and the conductive part 121 of the fixed electrode part 120, ΔC is obtained, such that the sound wave may be converted into the electric signal through the ΔC.

Meanwhile, in the case of calculating ΔC through the change in g, which is the distance between the membrane 110 and the fixed electrode part 120, ΔC is not linearly changed, but linearly changed according to the change in A.

Therefore, in the microphone 100 according to the preferred embodiment of the present invention, as ΔC is detected through the change in the area of the overlapped portion between the conductive part 111a of the membrane 110 and the conductive part 121 of the fixed electrode part 120, the sound wave may be more accurately converted into the electric signal.

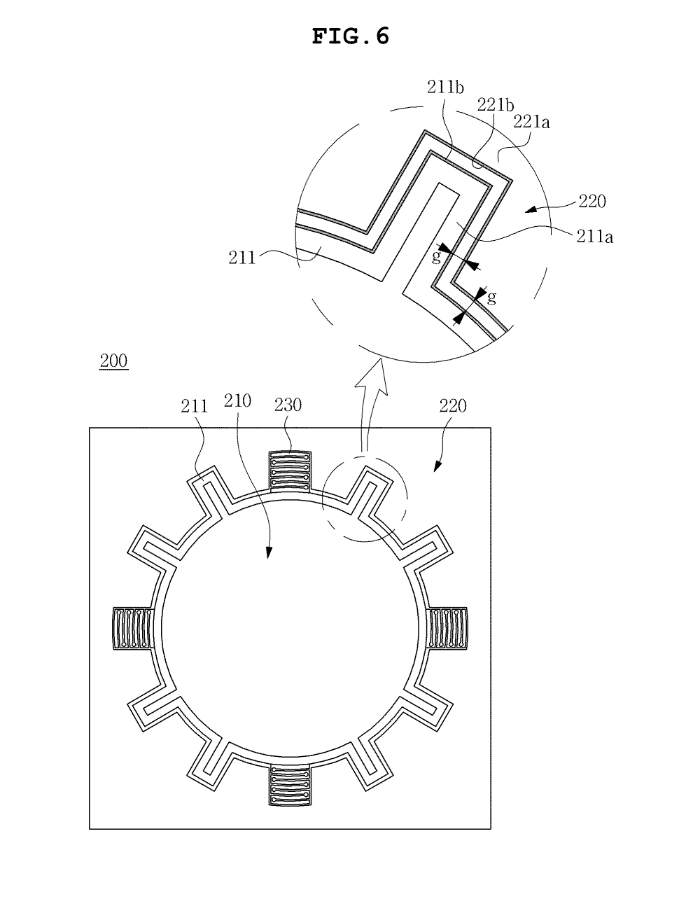

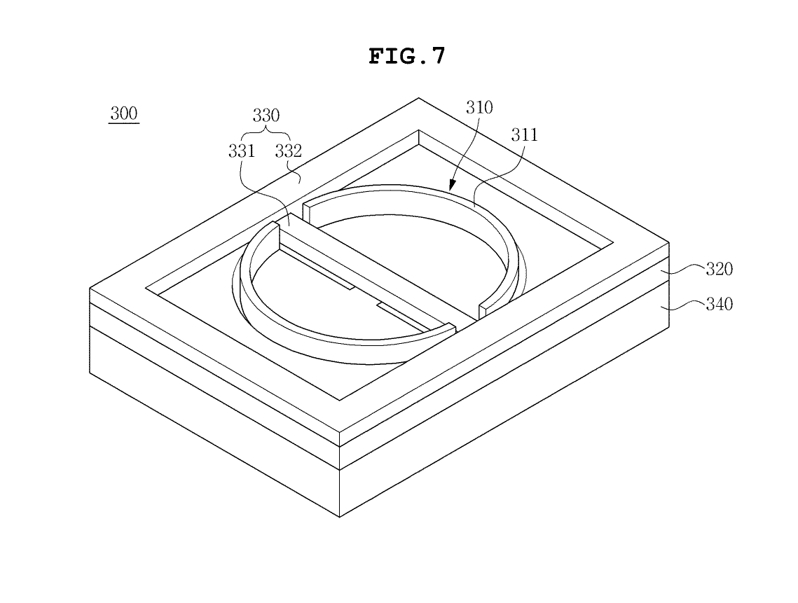

FIG. 6 is a plan view schematically showing a microphone according to a second preferred embodiment of the present invention. As shown in FIG. 6, in the microphone 200, only shapes of a membrane and a fixed electrode part are different from those of the microphone 100 according to the first preferred embodiment of the present invention as shown in FIG. 2.

More specifically, the microphone 200 includes a membrane 210, a fixed electrode part 220, an elastic support part 230, and a support part (not shown).

In addition, an end portion of the membrane 210 is provided with a side wall part 211 in a direction orthogonal to a displacement direction. In addition, as the membrane 210 has a disk shape, an end portion thereof in a radial direction is provided with the side wall part 211 in a circumferential direction.

Further, a plurality of protrusion parts 211a protruding toward the fixed electrode part are formed at the side wall part 211 at equidistance, and one surface of the side wall part 211 including the protrusion part 211a facing the fixed electrode part 220 may be formed with a conductive part 211b.

Further, the protrusion part 211a is to further increase a formation area of the conductive part and maximize the area of the overlapped portion with the conductive part of the fixed electrode part facing the conductive part to thereby maximize the change in capacitance. In addition, although a square shaped protrusion part is shown by way of example in FIG. 6, the present invention is not limited thereto, but the protrusion part may be implemented in various shapes such as a semi-circular shape, or the like.

In addition, as the membrane 210 is formed as the thin film, the side wall part 211 may be formed at the end portion of the membrane 210 so as to protrude in the displacement direction of the membrane 410.

Next, the fixed electrode part 220 is positioned at an outer peripheral portion of the membrane 210. In addition, the fixed electrode part 220 may be positioned at the outer peripheral portion of the membrane in the direction orthogonal to the displacement direction of the membrane 210.

Further, the fixed electrode part 220 may be disposed to be spaced apart from the side wall part 211 of the membrane 210 so as to have a predetermined gap g therebetween.

In addition, a groove part 221a is formed in the fixed electrode part 220 so as to correspond to the protrusion part 211a of the membrane 210.

Further, as shown in an enlarged view of FIG. 6, a conductive part 221b of the fixed electrode part 220 is formed so as to face the conductive part 211b formed on the side wall part 211 of the membrane 210.

In addition, similarly to the microphone according to the first preferred embodiment of the present invention as shown in the enlarged view of FIG. 4, an end portion of the conductive part 211b formed on the side wall part 211 of the membrane 210 may be formed so as to be positioned at the center of the conductive part 221b of the fixed electrode part 220 in a vibration direction of the membrane 210.

Therefore, in the microphone 200 according to the second preferred embodiment of the present invention, the area of the overlapped portion between the conductive part 211b of the membrane 210 and the conductive part 221b of the fixed electrode part 220 is maximized, and ΔC is detected through this change in the area, such that the sound wave may be more accurately converted into the electric signal.

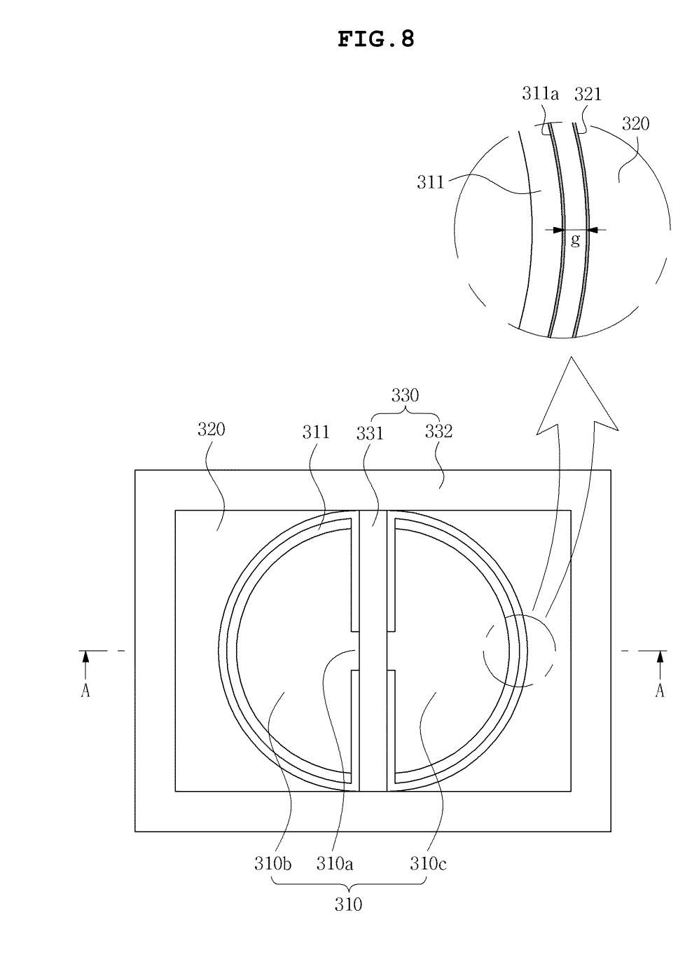

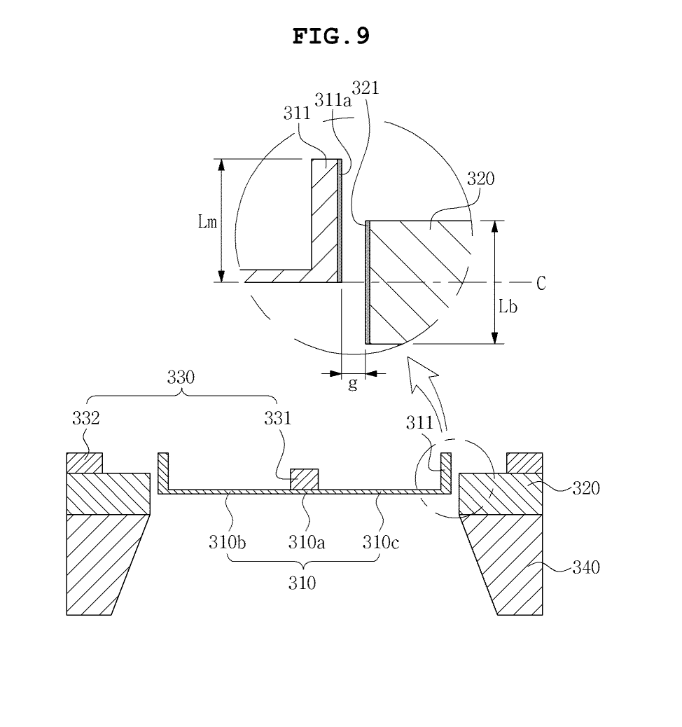

FIG. 7 is a perspective view schematically showing a microphone according to a third preferred embodiment of the present invention, FIG. 8 is a schematic plan view of the microphone shown in FIG. 7, and FIG. 9 is a cross-sectional view showing the microphone taken along line A-A of FIG. 7. As shown in FIGS. 7 to 9, the microphone 300 includes a membrane 310, a fixed electrode part 320, a support member 330, and a support part 340.

In addition, when a sound wave is applied to the microphone 300 according to the third preferred embodiment of the present invention from the outside, displacement is generated at both sides of the membrane 310 in a state in which a central portion of the membrane 310 is fixed by the support member 330, and a change in capacitance with respect to an overlapped surface of the fixed electrode part 320 and the membrane 310 by the displacement is detected, such that the sound wave is converted into an electric signal.

More specifically, the membrane 310, which is to be displaced by the sound wave, may be formed of a thin film in a disk shape In addition, as described above, the membrane 310 has a shape in which both side parts symmetrical to each other are connected so as to face each other based on a center part in order to generate symmetric displacement according to seesaw movement at both sides in a state in which the center part is fixed. To this end, the membrane 310 includes the central portion 310a, one side part 310b, and the other side part 310c.

In addition, the membrane 310 may have conductivity and be formed so that a conductive part is formed on at least some thereof. That is, in order to detect the change in capacitance generated at surfaces of the fixed electrode part 320 and the membrane 310 facing each other, a conductive part is formed on one surface of the membrane 310 facing the fixed electrode part 320.

To this end, a side wall part 311 is formed at an end portion of the membrane 310 in a direction orthogonal to a displacement direction, that is, an end portion thereof in a circumferential direction, and a conductive part 311a is formed on the side wall part 311 so as to face the fixed electrode part 320.

In addition, as the membrane 310 is formed as the thin film, the side wall part 311 may be formed at the end portion of the membrane 310 so as to protrude in the displacement direction of the membrane 410.

Next, the fixed electrode part 320, which is to form ΔC with a change in an area of an overlapped portion between the fixed electrode part 320 and the membrane 310, is positioned at an outer peripheral portion of the membrane 310.

In addition, the fixed electrode part 320 may be positioned at the outside of the membrane 310 in the direction orthogonal to the displacement direction of the membrane 310.

Further, the fixed electrode part 320 may be disposed to be spaced apart from the membrane 310 so as to have a predetermined gap g therebetween. The reason is to allow strong wind or low frequency flow to be discharged through the gap between the membrane 310 and the fixed electrode part 320 to thereby prevent the deformation of the membrane and allow the membrane 310 to be freely displaced by the sound wave in a vertical direction.

In addition, a conductive part 321 is formed on the fixed electrode part 320 so as to face the conductive part 311a formed on the side wall part of the membrane 310.

Further, as shown in an enlarged view of FIG. 9, an end portion of the conductive part 311a of the membrane 310 may be formed so as to be positioned at the center of the conductive part 321 of the fixed electrode part 320 in the displacement direction of the membrane 110.

That is, in the displacement direction of the membrane 310, when a length of the conductive part 311a of the membrane 310 is defined as Lm and a length of the conductive part 321 of the fixed electrode part 320 is defined as Lb, the end portion of the conductive part 311a is positioned at a portion corresponding to Lb×½, which is the center of the conductive part 321, and a distance at which the membrane 310 may be maximally moved by the sound pressure becomes Lb×½.

Next, the support member 330 connects the membrane 310 and the fixed electrode part 320 to each other. Further, the support member 330 is to allow displacement to be generated at both sides of the membrane 310 based on the center part thereof. In addition, symmetric displacement may be generated at both sides of the membrane 310 based on the center part thereof.

To this end, the support member 330 may include a center fixing part 331 and a frame part 332. Further, the center fixing part 331 is formed so as to correspond to the central portion 310a of the membrane 310.

In addition, the frame part 332 may be formed so as to correspond to the fixed electrode part 320 and fixedly coupled to the fixed electrode part 320.

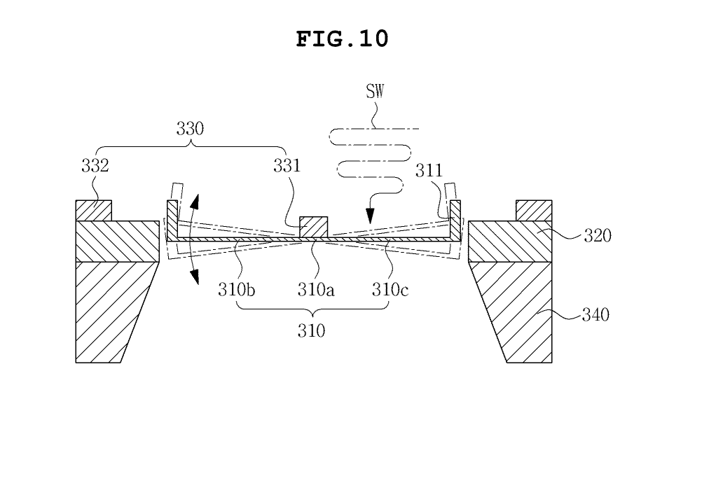

FIG. 10 is a view of schematically showing a use state of the microphone shown in FIG. 7. As shown in FIG. 10, in the case in which a sound wave (SW) is applied to the membrane 310 from the outside, displacement is generated therein. That is, displacement is generated by the sound wave at one side part 310b and the other side part 310c of the membrane 310 in a state in which the center part 310a of the membrane 310 is fixed to the center fixing part 331 of the support member 330. In this case, the symmetric displacement according to the seesaw movement may be generated at one side part 310b and the other side part 310c.

That is, when one side part 310b descends, the other side part 310c ascends, and when one side part 310b ascends, the other side part 310c descends.

In addition, in the case in which displacement of the membrane 310 is generated, the area of the overlapped portion between the conductive part 311a of the membrane 310 and the conductive part 321 of the fixed electrode part 3201 is changed, such that capacitance is changed, and accordingly, ΔC is generated, thereby making it possible to convert the sound wave into the electric signal through ΔC.

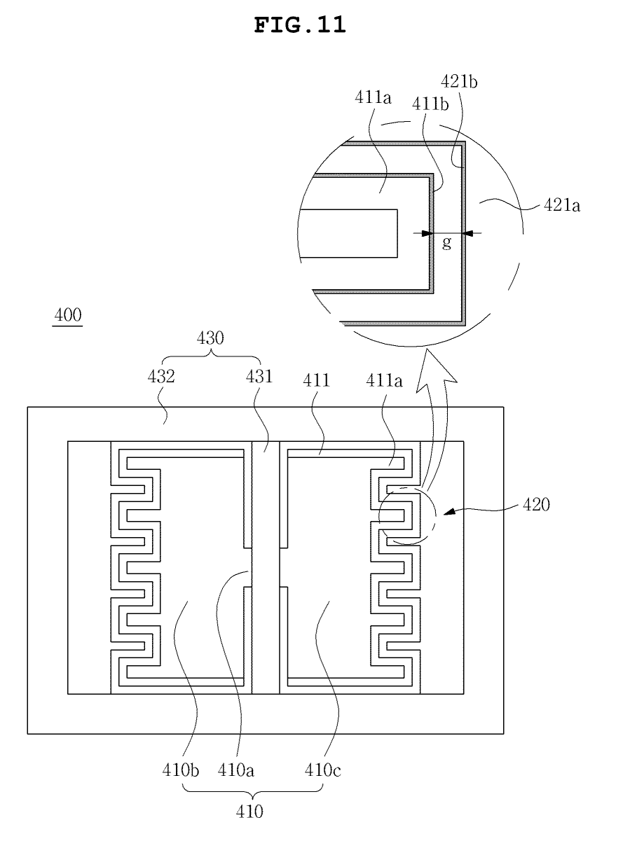

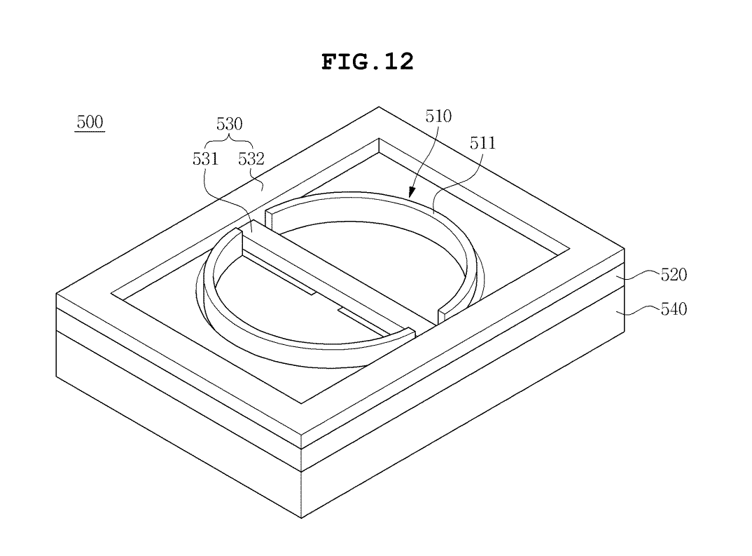

FIG. 11 is a plan view schematically showing a microphone according to a fourth preferred embodiment of the present invention. As shown in FIG. 11, in the microphone 400, only shapes of a membrane and a fixed electrode part are different from those of the microphone 300 according to the third preferred embodiment of the present invention as shown in FIG. 8.

More specifically, the microphone 400 includes a membrane 410, a fixed electrode part 420, a support part 430, and a support part (not shown).

In addition, when a sound wave is introduced into the microphone 400 according to the fourth preferred embodiment of the present invention from the outside, displacement is generated at both sides of the membrane 410 in a state in which a center part of the membrane 410 is fixed by the support member 430, and a change in capacitance with respect to an overlapped surface of the fixed electrode part 420 and the membrane 410 by the displacement is detected, such that the sound wave is converted into an electric signal.

More specifically, the membrane 410 may be displaced by the sound wave and formed of a thin film in a disk shape. In addition, as described above, the membrane 410 has a shape in which square parts symmetrical to each other are connected so as to face each other based on a center part in order to allow symmetric displacement to be generated at both sides in a state in which the center part is fixed. To this end, the membrane 410 includes the center part 410a, one side part 410b, and the other side part 410c.

In addition, an end portion of the membrane 410 in a direction orthogonal to a displacement direction may be formed with a side wall part 411, the side wall part 411 may be formed with a plurality of protrusion parts 411a protruding toward the fixed electrode part at equidistance, and one surface of the side wall part 411 including the protrusion part 411a facing the fixed electrode part 420 may be formed with a conductive part 411b.

Further, the protrusion part 411a is to further increase a formation area of the conductive part and maximize the area of the overlapped portion with the conductive part of the fixed electrode part facing the conductive part to thereby maximize the change in capacitance. In addition, although a square shaped protrusion part is shown by way of example in FIG. 11, the present invention is not limited thereto, but the protrusion part may be implemented in various shapes such as a semi-circular shape, or the like.

In addition, as the membrane 410 is formed as the thin film, the side wall part 411 may be formed at the end portion of the membrane 410 so as to protrude in the displacement direction of the membrane 410.

Next, the fixed electrode part 420 is positioned at an outer peripheral portion of the membrane 410. In addition, the fixed electrode part 420 may be positioned at the outer peripheral portion in the direction orthogonal to the displacement direction of the membrane 410.

Further, the fixed electrode part 420 may be disposed to be spaced apart from the side wall part 411 of the membrane 410 so as to have a predetermined gap g therebetween.

In addition, a groove part 421a is formed in the fixed electrode part 420 so as to correspond to the protrusion part 411a of the membrane 410.

In addition, a conductive part 421b is formed on a surface the fixed electrode part 420 facing the membrane 410. Further, as shown in an enlarged view of FIG. 11, the conductive part 421b of the fixed electrode part 420 is formed so as to face the conductive part 411b formed on the side wall part 411 of the membrane 410.

In addition, similarly to the microphone according to the first preferred embodiment of the present invention as shown in the enlarged view of FIG. 4, an end portion of the conductive part 411b formed on the side wall part 411 of the membrane 410 may be formed so as to be positioned at the center of the conductive part 421b of the fixed electrode part 420 in the displacement direction of the membrane 410.

Therefore, in the microphone 400 according to the fourth preferred embodiment of the present invention, the area of the overlapped portion between the conductive part 411b of the membrane 410 and the conductive part 421b of the fixed electrode part 420 is maximized, and ΔC is detected by this change in the area, such that the sound wave may be more accurately converted into the electric signal.

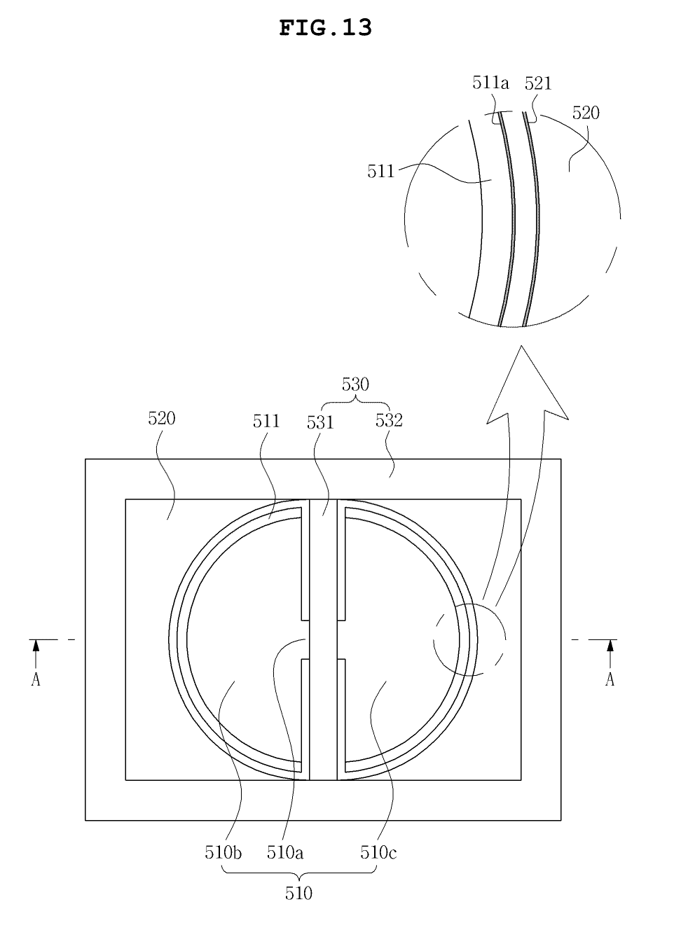

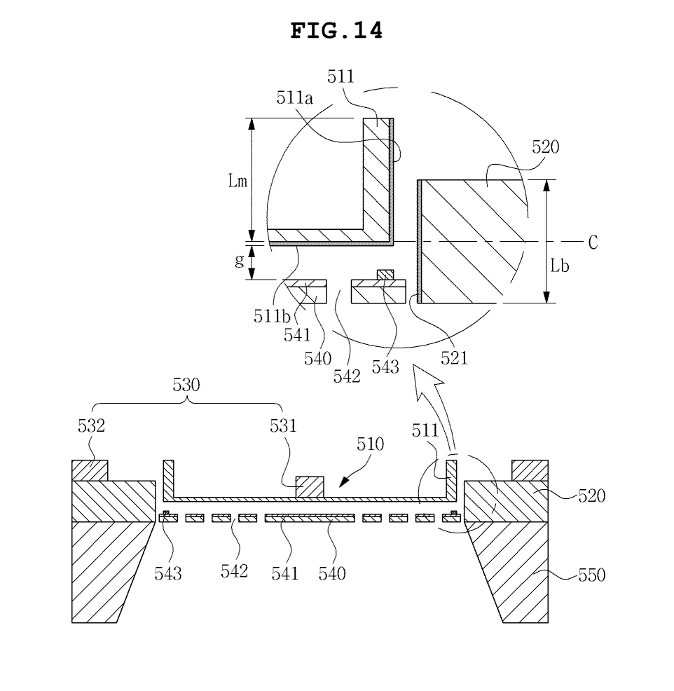

FIG. 12 is a perspective view schematically showing a microphone according to a fifth preferred embodiment of the present invention, FIG. 13 is a schematic plan view of the microphone shown in FIG. 12, and FIG. 14 is a cross-sectional view showing the microphone taken along line A-A of FIG. 12.

As shown in FIGS. 12 to 14, the microphone 500 includes a membrane 510, a fixed electrode part 520, a support member 530, a back plate 540 and a support part 550.

More specifically, when a sound wave is applied to the microphone 500 from the outside, displacement is generated at both sides of the membrane 510 in a state in which a central portion of the membrane 510 is fixed by the support member 530, an area of an overlapped portion between the fixed electrode part 520 and the membrane 510 is changed by the displacement, and at the same time, a distance between the membrane 510 and the back plate 540 is changed.

Therefore, the microphone 500 simultaneously measures the changes in the area of the overlapped portion and the distance and detects a change in capacitance according to the measured change, thereby converting the sound wave into an electric signal.

To this end, the membrane 510, which is to be displaced by the sound wave, may be formed of a thin film in a disk shape. In addition, as described above, the membrane 510 has a shape in which both side parts symmetrical to each other are connected so as to face each other based on a center part in order to allow symmetric displacement to be generated at both sides in a state in which the center part is fixed. That is, the membrane 510 includes the center part 510a, one side part 510b, and the other side part 510c.

In addition, the membrane 510 may have conductivity and be formed so that a conductive part is formed on at least some thereof. To this end, first and second conductive parts 511a and 511b are formed in the membrane 510.

In addition, the first conductive part 511a, which is to detect the change in the area of the overlapped portion that is a facing surface between the fixed electrode part 520 and the membrane 510, is formed on one surface of the membrane 510 facing the fixed electrode part 520.

In addition, a side wall part 511 is formed at an end portion of the membrane 510 in a direction orthogonal to a displacement direction, that is, an end portion thereof in a circumferential direction, and the first conductive part 511a is formed on the side wall part 511 so as to face the fixed electrode part 520.

Further, as the membrane 510 is formed of a thin film, in order to secure a space for forming the conductive part, the side wall part 511 is formed at the end portion of the membrane so as to protrude in the displacement direction of the membrane 510.

In addition, the second conductive part 511b, which is to detect a change in a distance g between the back plate 540 and the membrane 510, is formed on one surface of the membrane 510 facing the back plate 540. That is, as the back plate 540 is positioned below the membrane 510, the second conductive part 511b may be formed on a lower surface of the membrane 510 facing the back plate 540.

Next, the fixed electrode part 520, which is to form ΔC through a change in the area of the overlapped portion between the fixed electrode part 520 and the membrane 510, is positioned at an outer peripheral portion of the membrane 510.

In addition, the fixed electrode part 520 may be positioned at the outside of the membrane 510 in the direction orthogonal to the displacement direction of the membrane 510.

Further, the fixed electrode part 520 may be disposed to be spaced apart from the membrane 510 so as to have a predetermined gap therebetween. The reason is to allow strong wind or low frequency flow to be discharged through the gap between the membrane 510 and the fixed electrode part 520 to thereby prevent the deformation of the membrane and allow the membrane 510 to be freely displaced by the sound wave in a vertical direction.

In addition, a conductive part 521 is formed on the fixed electrode part 520 so as to face the first conductive part 511a formed on the side wall part of the membrane 510.

Further, as shown in an enlarged view of FIG. 14, an end portion of the conductive part 511a of the membrane 510 may be formed so as to be positioned at the center C of the conductive part 521 of the fixed electrode part 520 in the displacement direction of the membrane 510.

That is, in the displacement direction of the membrane 510, when a length of the first conductive part 511a of the membrane 510 is defined as Lm and a length of the conductive part 521 of the fixed electrode part 520 is defined as Lb, the end portion of the first conductive part 511a is positioned at a portion corresponding to Lb×½, which is the center of the conductive part 521, and a distance at which the membrane 510 may be maximally moved by the sound pressure becomes Lb×½.

Next, the support member 530 connects the membrane 510 and the fixed electrode part 520 to each other. Further, the support member 530 is to allow displacement to be generated at both sides of the membrane 510 based on the center part thereof. In addition, symmetric displacement may be generated at both sides of the membrane 510 based on the center part thereof.

To this end, the support member 530 may include a center fixing part 531 and a frame part 532. In addition, the center fixing part 531 may be formed so as to correspond to the center part 510a of the membrane 510 and coupled to the center part 510a.

In addition, the frame part 532 may be formed so as to correspond to the fixed electrode part 520 and fixedly coupled to the fixed electrode part 520.

Next, the back plate 540 is to detect the change value of the capacitance through the change in the distance between the back plate 540 and the membrane 510. To this end, the back plate 540 is positioned so as to have the predetermined gap g with the membrane 510 in the displacement direction of the membrane 510. In addition, a conductive part 541 is formed on the back plate 540 so as to face the second conductive part 511b of the membrane 510. In addition, a hole 542 is formed in the back plate 540 for a flow of the sound wave, and a stopper 543 may be formed at one surface facing the membrane.

Further, the stopper 543, which is to limit excessive displacement of the membrane 510, may be formed so as to face the end portion of the membrane 510 at which maximum displacement is generated.

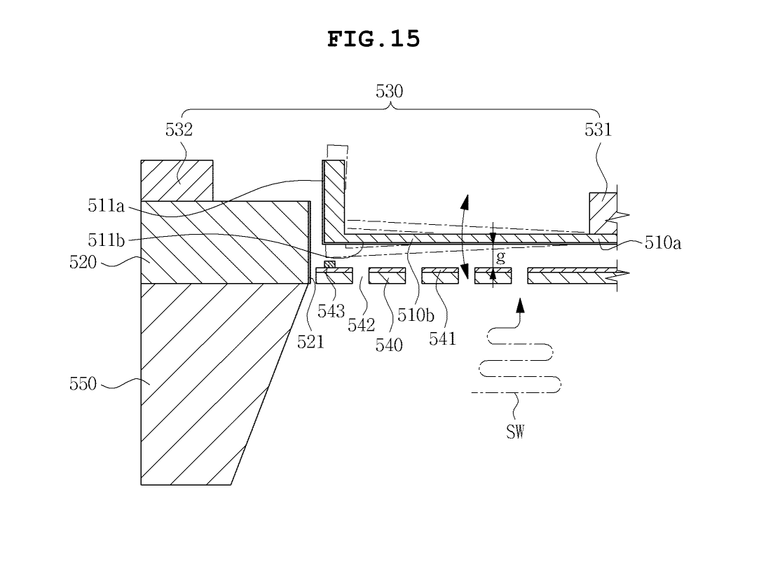

FIG. 15 is a view of a usage state of the microphone shown in FIG. 12. As shown in FIG. 15, in the case in which the sound wave (SW) is applied to the membrane 510 from the outside, displacement is generated therein. That is, displacement is generated at one side part 510b and the other side part 510c of the membrane 510 in a state in which the center part 510a of the membrane 510 is fixed to the center fixing part 531 of the support member 530. In this case, symmetric displacement according to the seesaw movement may be generated at one side part 510b and the other side part 510c. That is, when one side part 510b descends, the other side part 510c may ascend, and when one side part 510b ascends, the other side part 510c may descend.

In addition, in the case in which displacement of the membrane 510 is generated, the area of the overlapped portion between the first conductive part 511a of the membrane 510 and the conductive part 521 of the fixed electrode part 520 is changed.

In addition, a distance between the second conductive part 511b of the membrane 510 and the conductive part 541 of the back plate 540 is changed.

That is, capacitance C is defined as follows.

C=εr·ε·A/g

(Where, εr=permittivity, ε=electric constant, A=area of overlapped portion, and g=distance between the membrane and the back plate.)

Here, as the area A of the overlapped portion and the distance g are changed, the capacitance is changed and ΔC is calculated, such that the sound wave may be converted into the electric signal through ΔC.

As described above, the microphone 500 according to the fifth preferred embodiment of the present invention may be implemented as a more accurate microphone by simultaneously detecting the displacement of the area of the overlapped portion between the membrane 510 and the fixed electrode part 520 and distance displacement between the membrane 510 and the black plate to calculate ΔC and converting the sound wave into the electric signal through the calculated ΔC.

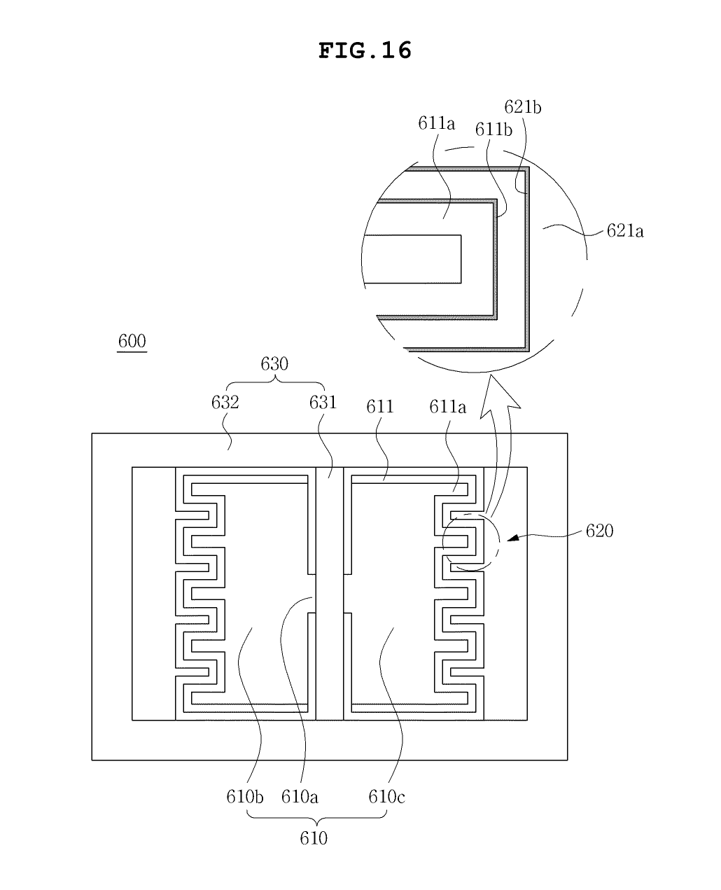

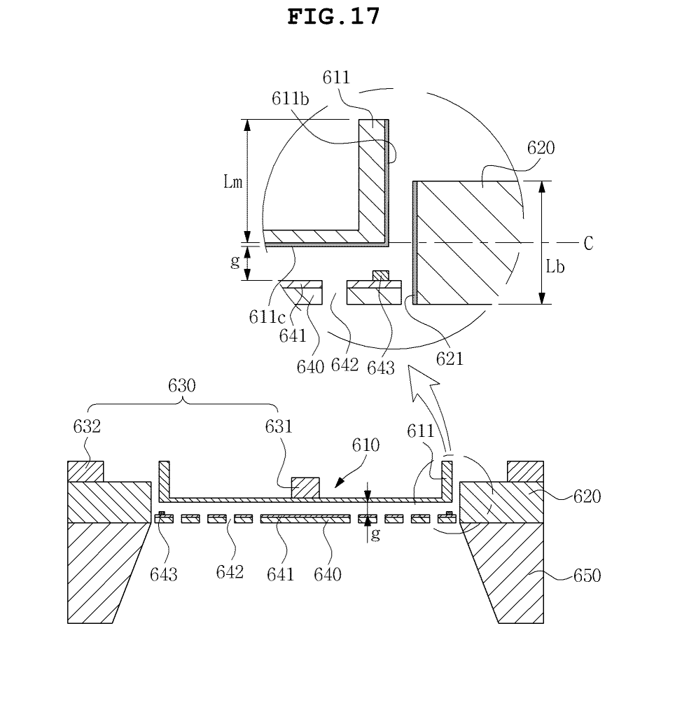

FIG. 16 is a plan view schematically showing a microphone according to a sixth preferred embodiment of the present invention, and FIG. 17 is a cross-sectional view showing the microphone taken along line A-A of FIG. 16. As shown in FIGS. 16 and 17, in the microphone 600, only shapes of a membrane and a fixed electrode part are different from those of the microphone 500 according to the fifth preferred embodiment of the present invention as shown in FIG. 13.

More specifically, the microphone 600 includes a membrane 610, a fixed electrode part 620, a support member 630, a back plate 640 and a support part 650.

In addition, when a sound wave is introduced to the microphone 600 according to the sixth preferred embodiment of the present invention from the outside, displacement is generated at both sides of the membrane 610 in a state in which a center part thereof is fixed by the support member 630, and a change value in capacitance with respect to an overlapped surface of the fixed electrode part 620 and the membrane 610 by the displacement is detected, such that the sound wave is converted into an electric signal.

More specifically, the membrane 610 may be displaced by the sound wave and formed of a thin film in a disk shape. In addition, as described above, the membrane 610 has a shape in which both side parts symmetrical to each other are connected so as to face each other based on the center part in order to allow symmetric displacement to be generated at both sides in a state in which the center part is fixed. To this end, the membrane 610 includes the center part 610a, one side part 610b, and the other side part 610c.

In addition, the membrane 610 may have conductivity and be formed so that a conductive part is formed on at least some thereof. To this end, first and second conductive parts 611b and 611c are formed in the membrane 610.

A side wall part 611 is formed at an end portion of the membrane 610 in a direction orthogonal to a displacement direction, and a plurality of protrusion parts 611a protruding toward the fixed electrode part are formed at the membrane 610 at equidistance. In addition, the side wall part 611 including the protrusion part 611a may include the first conductive part 611b formed on one surface thereof facing the fixed electrode part 620.

Further, the protrusion part 611a is to further increase a formation area of the conductive part and maximize an area of an overlapped portion with a conductive part of the fixed electrode part facing the conductive part to thereby maximize a change in capacitance. In addition, although a square shaped protrusion part is shown by way of example in FIG. 16, the present invention is not limited thereto, but the protrusion part may be implemented in various shapes such as a semi-circular shape, or the like.

In addition, as the membrane 610 is formed as the thin film, the side wall part 611 may be formed at the end portion of the membrane 610 so as to protrude in the displacement direction of the membrane 610.

In addition, the second conductive part 611c, which is to detect a change in a distance g between the back plate 640 and the membrane 610, is formed on one surface of the membrane 610 facing the back plate 640. That is, as the back plate 640 is positioned below the membrane 610, the second conductive part 611c may be formed on a lower surface of the membrane 610 facing the back plate 640.

Next, the fixed electrode part 620 is positioned at an outer peripheral portion of the membrane 610. In addition, the fixed electrode part 620 may be positioned at the outer peripheral portion in the direction orthogonal to the displacement direction of the membrane 610.

Further, the fixed electrode part 620 may be disposed to be spaced apart from the side wall part 611 of the membrane 610 so as to have a predetermined gap therebetween.

In addition, a groove part 621a is formed in the fixed electrode part 620 so as to correspond to the protrusion part 611a of the membrane 610.

In addition, a conductive part 421b is formed on a surface of the fixed electrode part 620 facing the membrane 610. Further, as shown in an enlarged view of FIG. 16, the conductive part 621b of the fixed electrode part 620 is formed so as to face the first conductive part 611b formed on the side wall part 611 of the membrane 610.

In addition, an end portion of the first conductive part 611b formed on the side wall part 611 of the membrane 610 may be formed so as to be positioned at the center C of the conductive part 621b of the fixed electrode part 620 in the displacement direction of the membrane 610. Next, the support member 630 connects the membrane 610 and the fixed electrode part 620 to each other. Further, the support member 630 is to allow displacement to be generated at both sides of the membrane 610 based on the center part thereof. In addition, symmetric displacement may be generated at both sides of the membrane 610 based on the center part thereof.

To this end, the support member 630 may include a center fixing part 631 and a frame part 632. In addition, the center fixing part 631 may be formed so as to correspond to the center part 610a of the membrane 610 and coupled to the center part 610a.

In addition, the frame part 632 may be formed so as to correspond to the fixed electrode part 620 and fixedly coupled to the fixed electrode part 620.

Next, the back plate 640 is to detect the change value of the capacitance through the change in the distance between the back plate 640 and the membrane 610. To this end, the back plate 640 is positioned so as to have the predetermined gap g with the membrane 610 in the displacement direction of the membrane 610. In addition, the back plate 640 may be positioned below the membrane. Further, a conductive part 641 is formed on the back plate 640 so as to face the second conductive part 611c of the membrane 610. In addition, the back plate 640 may include a hole 642 formed therein for a flow of the sound wave and a stopper 643 formed at an end portion thereof.

Further, the stopper 643, which is to limit excessive displacement of the membrane 610, may be formed to face both end portions of the membrane at which maximum displacement is generated.

Through the above-mentioned configurations, the microphone 600 according to the sixth preferred embodiment of the present invention may be implemented as a more accurate microphone by maximizing the area of the overlapped portion between the first conductive part 611b of the membrane 610 and the conductive part 621b of the fixed electrode part 620, detecting ΔC by the displacement of the area of the overlapped portion between the membrane 610 and the fixed electrode part 620 and distance displacement between the membrane 610 and the black plate 640, and converting the sound wave into the electric signal through the detected ΔC.

According to the present invention, it is possible to obtain the microphone capable of more accurately converting the sound wave into the electric signal by detecting the change value of the capacitance through the change in the area of the overlapped portion between the fixed electrode part positioned in the direction orthogonal to the displacement direction of the membrane and the membrane, decreasing the production cost by being implemented without the back plate, obtaining high sensitivity without air-resistance or air damping by the back plate, and linearly reacting to the sound pressure and having a simple structure to thereby have improved productivity and product reliability.

In addition, according to the present invention, it is possible to obtain the microphone capable of more accurately converting the sound wave into the electric signal by detecting the change value of the capacitance through the change in the area of the overlapped portion between the fixed electrode part positioned in the direction orthogonal to the displacement direction of the membrane and the membrane, and capable of being more accurately implemented by simultaneously detecting the change value of the area of the overlapped portion between the membrane and the fixed electrode part and the distance displacement between the membrane and the black plate, calculating the change value of the capacitance using the detected value, and converting the sound wave into the electric signal through the change value of the capacitance.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A microphone comprising:
a membrane;
a fixed electrode part positioned at the outside of the membrane; and
an elastic support part connecting the membrane and the fixed electrode part to each other so as to enable displacement of the membrane,
wherein one surface of the membrane and one surface of the fixed electrode part facing each other are formed with conductive parts, respectively.

2. The microphone as set forth in claim 1, wherein the fixed electrode part is positioned so as to be spaced apart from the membrane in a direction orthogonal to a displacement direction of the membrane.

3. The microphone as set forth in claim 1, wherein a side wall part is formed at an end portion of the membrane in a direction orthogonal to a displacement direction of the membrane and a conductive part is formed on the side wall part so as to face the fixed electrode part.

4. The microphone as set forth in claim 3, wherein the membrane is formed of a thin film, and the side wall part is formed so as to protrude in the displacement direction of the membrane.

5. The microphone as set forth in claim 3, wherein a conductive part is formed on the fixed electrode part so as to face the conductive part formed on the side wall part of the membrane.

6. The microphone as set forth in claim 5, wherein an end portion of the conductive part formed on the side wall part of the membrane is positioned at the center of the conductive part of the fixed electrode part in the displacement direction of the membrane.

7. The microphone as set forth in claim 1, wherein the elastic support part connects the membrane and the fixed electrode part to each other in a direction orthogonal to a displacement direction of the membrane.

8. The microphone as set forth in claim 7, wherein a plurality of elastic support parts connect the membrane and the fixed electrode part to each other at equidistance.

9. The microphone as set forth in claim 1, further comprising a support part coupled to the fixed electrode part so as to support the fixed electrode part in the displacement direction of the membrane.

10. The microphone as set forth in claim 3, wherein a plurality of protrusion parts protruding toward the fixed electrode part are formed at the side wall part of the membrane, and a groove part corresponding to the protrusion part is formed at the fixed electrode part.

11. The microphone as set forth in claim 10, wherein conductive parts are formed on the protrusion part of the side wall part and the groove part of the fixed electrode part so as to face each other.

12. A microphone comprising:
a membrane;
a fixed electrode part positioned at the outside of the membrane; and
a support member coupled to a central portion of the membrane so as to enable displacement of the membrane at both sides thereof,
wherein one surface of the membrane and one surface of the fixed electrode part facing each other are formed with conductive parts, respectively.

13. The microphone as set forth in claim 12, wherein the fixed electrode part is positioned so as to be spaced apart from the membrane in a direction orthogonal to a displacement direction of the membrane.

14. The microphone as set forth in claim 12, wherein the membrane includes a center part to which the support member is coupled, and one side part and the other side part formed so as to be symmetrical to each other at both sides of the center part.

15. The microphone as set forth in claim 14, wherein shapes of one side part and the other side part are symmetrical to each other.

16. The microphone as set forth in claim 12, wherein a side wall part is formed at an end portion of the membrane in a direction orthogonal to a displacement direction of the membrane and a conductive part is formed on the side wall part so as to face the fixed electrode part.

17. The microphone as set forth in claim 16, wherein the membrane is formed of a thin film, and the side wall part is formed so as to protrude in the displacement direction of the membrane.

18. The microphone as set forth in claim 16, wherein a conductive part is formed on the fixed electrode part so as to face the conductive part formed on the side wall part of the membrane.

19. The microphone as set forth in claim 18, wherein an end portion of the side wall part of the membrane on which the conductive part is formed is positioned at the center of the conductive part of the fixed electrode part in the displacement direction of the membrane.

20. The microphone as set forth in claim 12, wherein the support member includes:
a center fixing part formed so as to correspond to the center part of the membrane; and
a frame part fixedly coupled to the fixed electrode part.

21. The microphone as set forth in claim 12, further comprising a support part coupled to the fixed electrode part so as to support the fixed electrode part in a displacement direction of the membrane.

22. The microphone as set forth in claim 16, wherein a plurality of protrusion parts protruding toward the fixed electrode part are formed at the side wall part of the membrane, and a groove part corresponding to the protrusion part is formed at the fixed electrode part.

23. The microphone as set forth in claim 22, wherein conductive parts are formed on the protrusion part of the side wall part and the groove part of the fixed electrode part so as to face each other.

24. A microphone comprising:
a membrane;
a fixed electrode part positioned at the outside of the membrane;
a back plate positioned at the outside of the membrane; and
a support member coupled to a central portion of the membrane so as to enable displacement at both sides of the membrane,
wherein one surface of the membrane and one surface of the fixed electrode part facing each other are formed with conductive parts, respectively, and one surface of the membrane and one surface of the back plate facing each other are formed with conductive parts, respectively.

25. The microphone as set forth in claim 24, wherein the fixed electrode part is positioned so as to be spaced apart from the membrane in a direction orthogonal to a displacement direction of the membrane.

26. The microphone as set forth in claim 24, wherein the back plate is positioned so as to be spaced apart from the membrane in a displacement direction of the membrane.

27. The microphone as set forth in claim 24, wherein the membrane includes a center part to which the support member is coupled, and one side part and the other side part formed so as to be symmetrical to each other at both sides of the center part.

28. The microphone as set forth in claim 24, wherein a side wall part is formed at an end portion of the membrane in a direction orthogonal to a displacement direction of the membrane and a first conductive part is formed on the side wall part so as to face the fixed electrode part.

29. The microphone as set forth in claim 28, wherein the membrane is formed of a thin film, and the side wall part is formed so as to protrude in the displacement direction of the membrane.

30. The microphone as set forth in claim 28, wherein a conductive part is formed on the fixed electrode part so as to face the first conductive part formed on the side wall part of the membrane.

31. The microphone as set forth in claim 28, wherein an end portion of the side wall part of the membrane on which the first conductive part is formed is positioned at the center of the conductive part of the fixed electrode part in the displacement direction of the membrane.

32. The microphone as set forth in claim 24, wherein the membrane includes a second conductive part formed so as to face the back plate in a displacement direction, and the back plate is positioned below the membrane and includes a conductive part formed so as to face the second conductive part.

33. The microphone as set forth in claim 32, wherein the back plate includes a hole formed for a flow of a sound wave and a stopper formed at one surface thereof facing the membrane.

34. The microphone as set forth in claim 24, wherein the support member includes:
a center fixing part formed so as to correspond to a center part of the membrane; and
a frame part fixedly coupled to the fixed electrode part.

35. The microphone as set forth in claim 34, further comprising a support part coupled to the fixed electrode part so as to support the fixed electrode part in a displacement direction of the membrane.

36. A microphone comprising:
a membrane;
a fixed electrode part positioned at the outside of the membrane;
a back plate positioned at the outside of the membrane; and
a support member coupled to a central portion of the membrane so as to enable displacement at both sides of the membrane,
wherein one surface of the membrane and one surface of the fixed electrode part facing each other are formed with conductive parts, respectively, one surface of the membrane and one surface of the back plate facing each other are formed with conductive parts, respectively, the membrane includes a plurality of protrusion parts protruding toward the fixed electrode part, and the fixed electrode part includes a groove part formed therein so as to correspond to the protrusion part.

37. The microphone as set forth in claim 31, wherein the protrusion part of the membrane and the groove parts of the fixed electrode parts are formed with conductive parts facing each other.

38. The microphone as set forth in claim 36, wherein the fixed electrode part is positioned so as to be spaced apart from the membrane in a direction orthogonal to a displacement direction of the membrane, and the back plate is positioned so as to be spaced apart from the membrane in the displacement direction of the membrane.

39. The microphone as set forth in claim 36, wherein the membrane includes a center part to which the support member is coupled, and one side part and the other side part formed so as to be symmetrical to each other at both sides of the center part.

40. The microphone as set forth in claim 36, wherein a side wall part protruding in a displacement direction of the membrane is formed at an end portion of the membrane in a direction orthogonal to the displacement direction of the membrane, and a first conductive part is formed on the side wall part so as to face the fixed electrode part.

41. The microphone as set forth in claim 36, wherein the membrane includes a second conductive part formed so as to face the back plate in a displacement direction, and the back plate is positioned below the membrane and includes a conductive part formed so as to face the second conductive part.

42. The microphone as set forth in claim 36, wherein the support member includes:
a center fixing part formed so as to correspond to a center part of the membrane; and
a frame part fixedly coupled to the fixed electrode part.
